(19) United States
(12) Patent Application Publication
(10) Pub. No.: US 2015/0360159 A1
(43) Pub. Date: Dec. 17, 2015

(54) Blended Fiber Filters

(71) Applicant: FiberVisions, L.P., Duluth, GA (US)

(72) Inventors: Zachary Lee, Duluth, GA (US); Prashant Desai, Duluth, GA (US)

(21) Appl. No.: 14/735,390

(22) Filed: Jun. 10, 2015

Related U.S. Application Data
(60) Provisional application No. 62/010,743, filed on Jun. 11, 2014.

(51) Int. Cl. B01D 39/16; D04H 1/435; D04H 1/4334; D04H 1/4382; D04H 1/4291

(52) U.S. Cl. CPC B01D 39/1623; D04H 1/4382; D04H 1/4291; D04H 1/4334; D04H 1/435; B01D 2239/064; B01D 2239/0636; B01D 2239/0618; D10B 2321/022; D10B 2321/021; D10B 2331/02; D10B 2331/04; D10B 2505/04

(57) ABSTRACT

A filter comprising a nonwoven blend of fibers is shown, where the nonwoven blend of fibers comprises a bi-component fiber bonded to a mono-component fiber. The bi-component fiber comprises a core and a sheath. The sheath and the core have different melting points, with the sheath melting point being lower than the core melting point. The mono-component fiber has a shaped cross-section.

### CROSS REFERENCE TO RELATED APPLICATIONS

This application claims the benefit of U.S. provisional patent application Ser. No. 62/010,743, filed 2014 Jun. 11, by FiberVisions Corporation, and having the title “Bi-Component and Shaped Mono-Component Fiber Blends for Air and Liquid Filtration,” which is incorporated herein by reference in its entirety.

### BACKGROUND

1. Field of the Disclosure

The present disclosure relates generally to textiles and, more particularly, to nonwovens.

2. Description of Related Art

Nonwovens (also called nonwoven fabrics) and related industries are important enough that organizations, such as EDANA and INDA, have supported various approaches to evaluating efficiency and permeability of nonwovens, including, for example, the approaches set forth in ASHRAE 52.2 and ERT EDANA 140.2-99. Within this industry, there are ongoing efforts to achieve better filter performance.

### SUMMARY

The present disclosure provides filters comprising a nonwoven blend of fibers. The nonwoven blend of fibers comprises a bi-component fiber bonded to a mono-component fiber. The bi-component fiber comprises a core and a sheath. The sheath and the core have different melting points, with the sheath melting point being lower than the core melting point. The mono-component fiber has a shaped cross-section.

Other systems, devices, methods, features, and advantages will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a diagram showing an electron micrograph of bonding between round fibers.

FIG. 2 is a diagram showing an electron micrograph of bonding between bi-component fibers and shaped mono-component fibers, in accordance with one embodiment of the invention.

FIG. 3 is a diagram showing an electron micrograph of bonding between bi-component fibers and shaped mono-component fibers, in accordance with another embodiment of the invention.

FIG. 4 is a table showing an experimental comparison of air flow pressure drops between a nonwoven of FIG. 1 and a nonwoven of FIG. 2 or 3.

FIG. 5 is a table showing experimental data showing a comparison between polypropylene (PP) mono-component fibers and polyester (PET) mono-component fibers for tensile strength and bonding characteristics.

FIG. 6 is a chart showing a plot of the data from FIG. 5

### DETAILED DESCRIPTION OF THE EMBODIMENTS

When designing filters from nonwovens, manufacturers typically consider fabric basis weight, porosity, fiber denier, and other factors. These factors affect filter performance, such as filtration efficiency, dust-holding capacity, air permeability, etc. Typically, there is a trade-off when designing these filters. With an increase in filter efficiency there is usually a decrease in air permeability, an increase in fabric basis weight, or some combination of both.

With increasing demands for higher filter efficiency, there exists a need for nonwovens that meet these efficiency demands without increasing fabric basis weight or sacrificing permeability. Furthermore, it is desirable for nonwovens to have sufficient stiffness, thereby reducing supports that may be required in manufacturing filter assemblies. It is particularly difficult to find a proper balance between efficiency and other factors for nonwovens that are fabricated solely with round fibers (i.e., fibers with round cross-sections). Unfortunately, nonwovens are usually manufactured solely with round fibers.

The disclosed embodiments solve this issue by providing filters comprising a nonwoven blend of fibers having bi-component fibers bonded to shaped mono-component fibers. The bi-component fibers permit proper thermal bonding (e.g., in thru-air dryers or bonding ovens, through infra-red (IR) or radiofrequency (RF) heating, etc.) to the shaped mono-component fibers and to other bi-component fibers. The shaped mono-component fibers increase filter efficiency without significantly adversely affecting permeability, as compared to nonwovens with round fibers and equivalent basis weights.

As shown in greater detail below, blended nonwovens of bi-component fibers and shaped mono-component fibers (which are developed for drylaid processing or thru-air bonding applications) can achieve higher filter efficiencies, yet have substantially the same equivalent basis weight and tensile strength as blends having only round fibers. For some embodiments, the bi-component fibers are thermoplastic staple fibers having a linear mass density (or titer) of between approximately 0.5 decitex (dtex) and approximately 30 dtex. In some embodiments, the mono-component fibers are also thermoplastic staple fibers having a linear mass density of between approximately 0.5 dtex and approximately 30 dtex. In various different embodiments, the shaped mono-component fibers have a cross-sectional shape that is round, trilobal, pentalobal, delta, hollow, flat, or cross-shaped.

Having described, generally, one embodiment of the invention, reference is now made in detail to the description of the embodiments as illustrated in the drawings. While several embodiments are described in connection with these drawings, there is no intent to limit the disclosure to the embodiment or embodiments disclosed herein. On the contrary, the intent is to cover all alternatives, modifications, and equivalents.

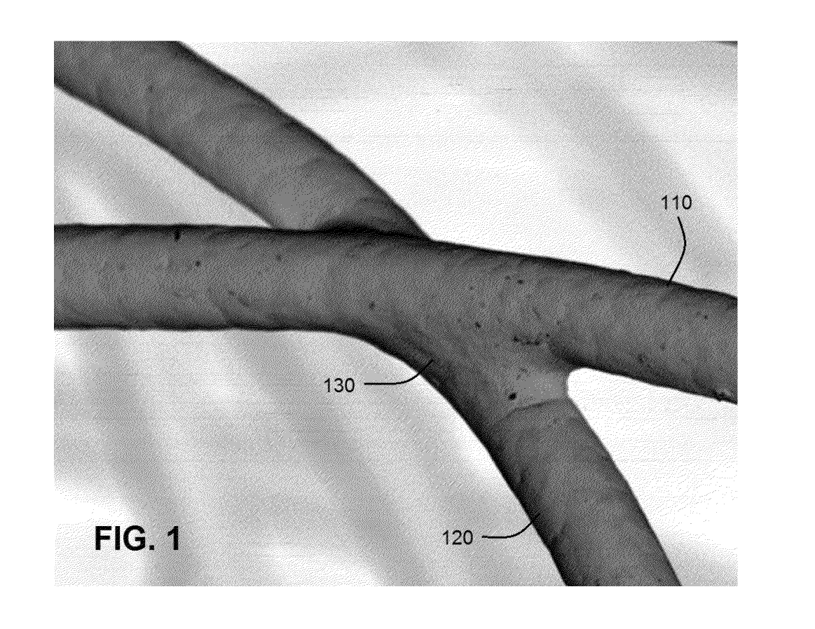

FIG. 1 is a diagram showing an electron micrograph of bonding between fibers with round cross-sections (also referred to herein as round fibers) in a nonwoven. The nonwoven in FIG. 1 shows two round fibers 110, 120 that are bonded together at an intersection 130. Basically, FIG. 1 shows the micrograph of a conventional nonwoven that uses only round fibers.

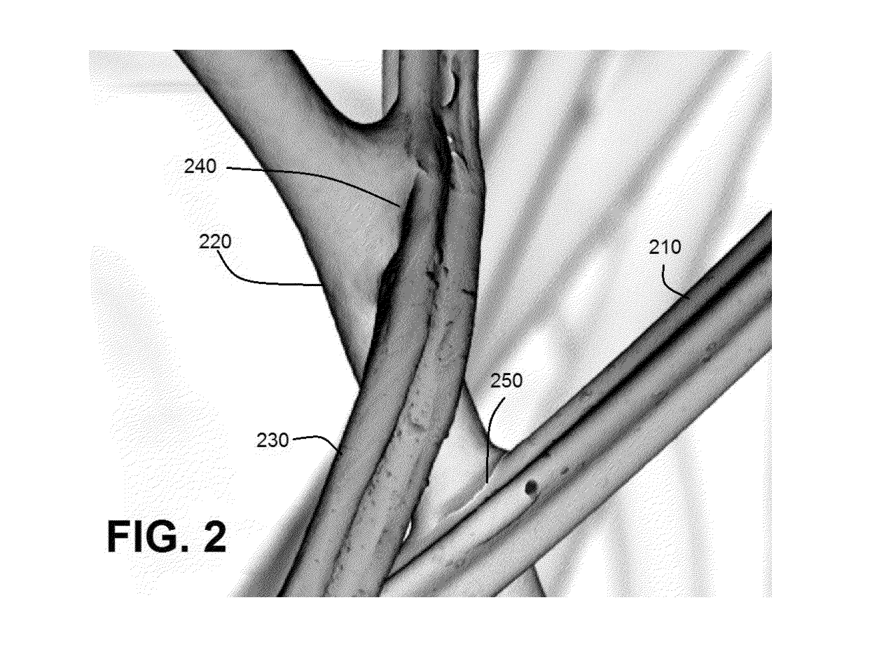

FIG. 2 is a diagram showing an electron micrograph of bonding between bi-component fibers and shaped mono-component fibers, in accordance with one embodiment of the invention. In particular, FIG. 2 shows a bi-component fiber 220 that intersects with two (2) shaped mono-component fibers 210, 230, which, in this embodiment, are trilobal polypropylene fibers. As shown in FIG. 2, the first mono-component fiber 210 bonds to the bi-component fiber 220 at an intersection 250, and the second mono-component fiber 230 bonds to the bi-component fiber 220 at another intersection 240. At the microscopic level, the embodiment of FIG. 2 appears remarkably different from the conventional round-fiber-only nonwoven of FIG. 1. This difference results in higher filter efficiency in FIG. 2 than in FIG. 1, but without significant increases in basis weight or significant decreases in permeability. Since bi-component fibers are known, such as those described in U.S. Pat. No. 4,406,850 (Spin pack and method for producing conjugate fibers) by Hills (“Hill Patent”), only a truncated discussion of bi-component fibers is provided here and the Hill Patent is incorporated herein by reference as if expressly set forth in its entirety.

For some embodiments, the bi-component fiber 220 comprises a core and a sheath, with the core having a higher melting point than the sheath. Also, for FIG. 2, the mono-component fibers 210, 230 also have a higher melting point than the sheath of the bi-component fiber 220. Thus, when heated, the sheath becomes molten before either the core or the mono-component fibers 210, 230. This permits the sheath of the bi-component fiber 220 to function as the bonding material, while the mono-component fibers 210, 230 and the core maintain structural integrity of the nonwoven. In other words, the core of the bi-component fiber 220 and the mono-component fibers 210, 230 provide the necessary network structure to provide tensile strength, stiffness, and porosity of the nonwoven. Preferably, the bi-component fiber 220 has a linear mass density of between approximately 0.5 dtex and approximately 30 dtex. Similarly, the mono-component fibers 210, 230 have linear mass densities of between approximately 0.5 dtex and approximately 30 dtex. These values provide sufficient structural integrity as well as appropriate filtration characteristics for the nonwoven.

It should be appreciated that the core of the bi-component fiber 220 can be a polyolefin, a polyester, a polyamide, a polylactic acid, any type of biodegradable thermoplastic polymer, or a variety of other types of polymers. Similarly, the sheath surrounding the core can be any type of polymer, such as a polyolefin, a co-polyester, a co-polyamide, etc., as long as the melting point of the sheath is lower than the melting point of the core. Likewise, the mono-component fibers 210, 230 can be a polyolefin, a co-polyester, a co-polyamide, a polypropylene, etc., as long as the mono-component fibers 210, 230 have a higher melting point than the sheath of the bi-component fiber 220.

The shaped cross-section of the mono-component fibers 210, 230 increases the available surface area of the mono-component fibers 210, 230 during filtration, thereby increasing the interface where the mono-component fibers 210, 230 can interact with diffusing particles during filtration. By providing a non-round cross-sectional shape, the mono-component fibers 210, 230 increase the tortuosity of the diffusion path, thus increasing filtration efficiency without increasing basis weight. Although a mono-component fiber 210 with a trilobal cross-section is shown FIG. 2, it should be appreciated that other shaped cross-sections (e.g., pentalobal, delta, hollow, flat, cross-shaped, etc.) will also increase the surface area more than a round cross-section, thereby increasing filtration efficiency.

It should be appreciated that the suitable shape and surface area of the mono-component fiber is dependent on the sizes of the particles that are being filtered, such that the increased surface area is accessible to the particles during filtration. Consequently, overly-complicated cross-sections may be undesirable for some applications, insofar as an overly-convoluted surface area may be less accessible to particles than simpler cross-sections (such as trilobal cross-sections). In other words, arriving at the appropriate cross-sectional shape is not simply a design choice or routine experimentation but, rather, a functional consideration based on particle size and desired filtration characteristics.

Also, it should be noted that the mono-component fibers need not be thermoplastic, since the mono-component fibers are not the main bonding fibers. Thus, the mono-component fibers can be acrylic, glass, or other non-thermoplastic fibers. However, thermoplastic mono-component fibers may have advantages, such as, for example, better bonding affinity to the bi-component fibers. For some embodiments, polypropylene shaped mono-component fibers are preferable because polypropylene is the lowest density polymer for a given mass linear density (e.g. for a given dtex), thereby providing greater surface area for a given dtex, as compared to other polymers. The lower density, therefore, results in greater filtration ability to filter, better bonding characteristics, better ability to charge medium, and advantageous triboelectric effects.

For some embodiments, it should be noted that round mono-component fibers can be used in conjunction with shaped mono-component fibers to increase the surface area (although to a lesser degree than using only shaped mono-component fibers). For other embodiments, one can appreciate that shaped bi-component fibers can also be used to further increase surface area. However, shaped bi-component fibers may result in increased costs that may outweigh the benefits of the increased surface area. Next, it should also be noted that a polypropylene sheath with a higher-melting-temperature polyester core can be used in conjunction with a polypropylene mono-component fiber. However, due to the similarity in the melting temperatures of the sheath and the mono-component fiber, problems may arise during the bonding process, such as, for example, during thru-air bonding. Thus, while careful process controls may reduce the likelihood of these types of problems, having polypropylene sheaths with polypropylene mono-component fibers may not be preferable.

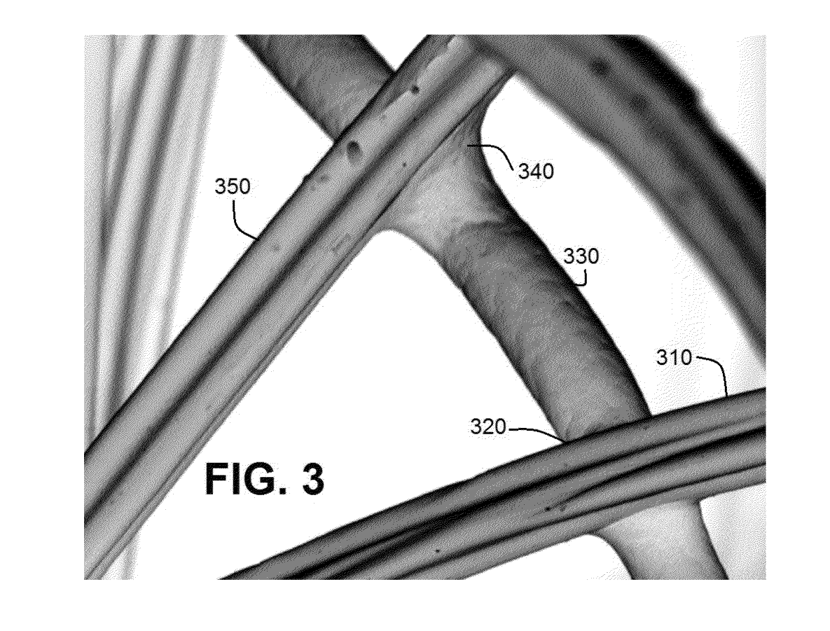

FIG. 3 is a diagram showing an electron micrograph of bonding between a bi-component fiber 330 and shaped mono-component fibers 310, 350, in accordance with another embodiment of the invention. Similar to FIG. 2, the embodiment of FIG. 3 shows the sheath of the bi-component fiber 330 bonded to the first shaped mono-component fiber 310 at an intersection 320, and also bonded to a second shaped mono-component fiber 350 at another intersection 340. Insofar as blended nonwovens with bi-component fibers and shaped mono-component fibers have been described in detail with reference to FIG. 2, further discussion of such blended nonwovens is omitted here.

To test the efficiency of blended nonwovens with bi-component fibers and shaped mono-component fibers, several different samples were manufactured using carding and thru-air bonding processes. Those samples used 3.3 dtex bi-component fibers (with polyethylene sheaths and polyester cores) blended with 1.33 dtex trilobal polypropylene mono-component fibers. Different blends were created, namely: (a) nonwoven blends comprising approximately 85% bi-component fibers and approximately 15% mono-component fibers; (b) nonwoven blends comprising approximately 75% bi-component fibers and approximately 25% mono-component fibers; and (c) nonwoven blends comprising approximately 65% bi-component fibers and approximately 35% mono-component fibers. FIGS. 2 and 3 reflect how well the bi-component fibers bonded with the shaped mono-component fibers. At this point, it is worthwhile to note that the proportions of bi-component and mono-component fibers can be varied, depending on the particular filtration needs. Thus, some embodiments may have up to approximately 50% mono-component fibers, while other embodiments have as low as approximately 5% mono-component fibers.

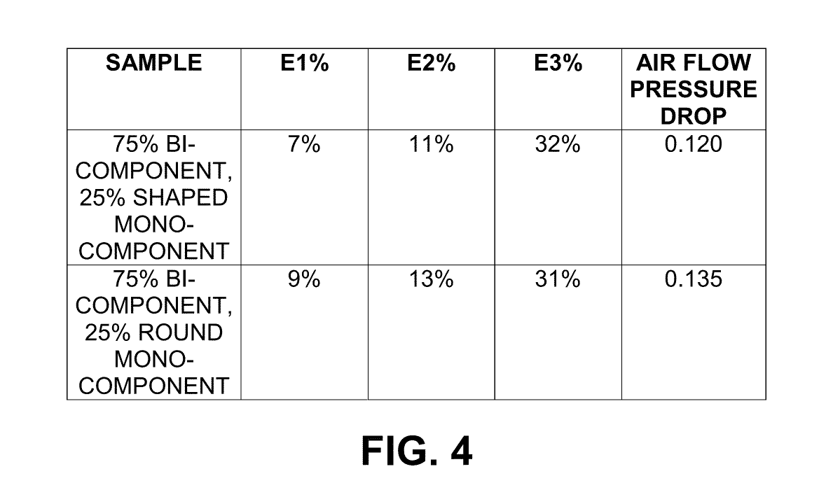

FIG. 4 is a table showing an experimental comparison of air flow pressure drops between a nonwoven of FIG. 1 and a nonwoven of FIG. 2 or 3. As shown in FIG. 4, the air flow pressure drop was compared for a nonwoven with a blend of 75% bi-component fibers and 25% shaped (trilobal) mono-component fibers, on one hand, and a blend of 75% bi-component fibers and 25% round mono-component fibers, on the other hand. These particular results show very low pressure drops due to lofty nonwovens.

It should be appreciated that the air filtration and mechanical properties can be significantly enhanced by further compressing the webs as they are bonded. Normally, there is a thickness control roll before the fabric enters an oven. However, the fabric can rebound and re-loft in the oven. Thus, it may be preferable to compress the web(s) immediately after the fabric exits the oven (rather than compressing the web(s) before the fabric enters the oven). By compressing immediately at the exit of the oven (or in very close proximity to the exit of the oven) the loft can be controlled while the fabric is still hot.

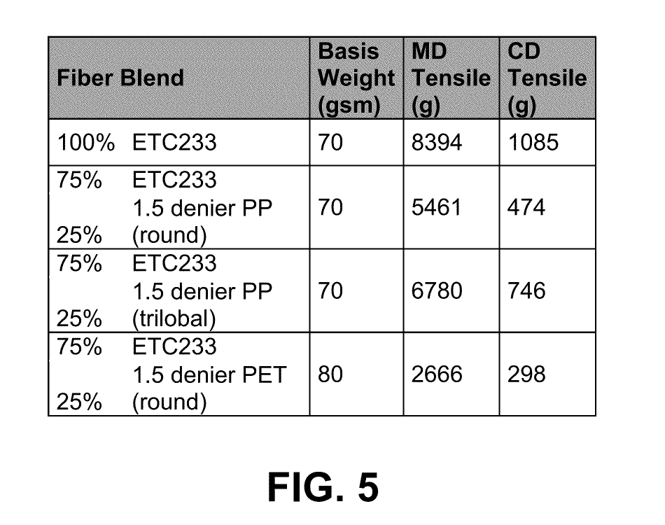

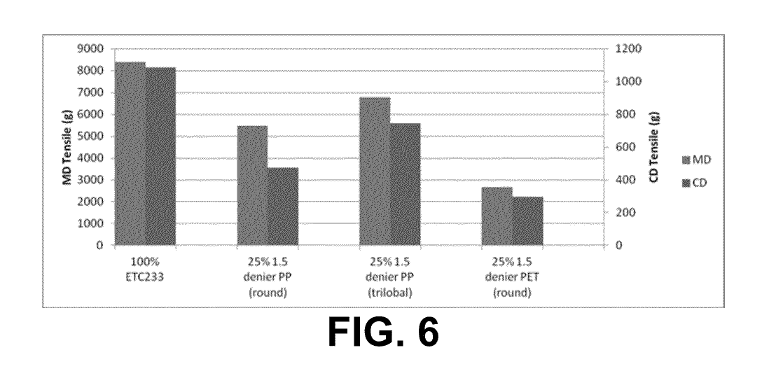

FIG. 5 is a table showing experimental data showing a comparison between polypropylene (PP) mono-component fibers and polyester (PET) mono-component fibers, while FIG. 6 is a chart showing a plot of the data from FIG. 5. As shown in FIGS. 5 and 6, for this embodiment, PP is more compatible with the bi-component sheath polymer, which results in a higher tensile strength. Conversely, for this embodiment, the PET mono-component fibers do not bond with the bi-component fibers. FIGS. 5 and 6 also show that an all-bi-component fabric is quite strong, but this is because all fibers are bonding fibers. Consequently, the PP mono-component blend (which has better binding with the bi-component fibers) is stronger than the PET mono-component blend (which does not bind well with the bi-component fibers).

Although exemplary embodiments have been shown and described, it will be clear to those of ordinary skill in the art that a number of changes, modifications, or alterations to the disclosure as described may be made. For example, while structural and performance benefits have been described with various embodiments of the invention, it should be appreciated that different combinations of fibers can be used for aesthetic purposes. For example, pigmented fibers can be used to provide aesthetically pleasing nonwovens. Additionally, pigmented fibers can be used to hide dirt on filters or, conversely, better show dirt on filters so that one knows when to change the filters. Furthermore, it should be appreciated that the fibers or the nonwovens can be impregnated with antimicrobials or other chemicals, depending on the particular use for the filters.

These and other such changes, modifications, and alterations should therefore be seen as within the scope of the disclosure.

What is claimed is:

1. A filter, comprising:
a nonwoven blend of fibers, the nonwoven blend comprising:
bi-component fibers having a linear mass density of between approximately 0.5 decitex (dtex) and approximately thirty (30) dtex, the bi-component fibers comprising:
a core having a first melting point, the core comprising a first polymer, the first polymer being one selected from the group consisting of:
a polyolefin;
a polyester;
a polyamide;
a polylactic acid; and
a biodegradable thermoplastic polymer; and
a sheath surrounding the core, the sheath having a second melting point, the second melting point being lower than the first melting point, the sheath comprising a second polymer, the second polymer being one selected from the group consisting of:
a polyolefin;
a co-polyester; and
a co-polyamide; and
mono-component fibers bonded to the bi-component fibers, the mono-component fibers having a linear mass density of between approximately 0.5 dtex and approximately 30 dtex, the mono-component fibers comprising a third polymer, the third polymer being one selected from the group consisting of:
a polyolefin;
a co-polyester;
a co-polyamide; and
a polypropylene;
the mono-component fibers having a shaped cross-section, the shaped cross-section being one selected from the group consisting of:
a trilobal cross-section;
a pentalobal cross-section;
a delta cross-section;
a hollow cross-section;
a flat cross-section; and
a cross-shaped cross-section.

2. The system of claim 1, the nonwoven blend of fibers comprising less than approximately 50% mono-component fibers and more than approximately 5% mono-component fibers.

3. The system of claim 1, the nonwoven blend of fibers comprising approximately 75% bi-component fibers and approximately 25% mono-component fibers.

4. The system of claim 3:
the bi-component fibers comprising a polyethylene sheath and a polyester core;
the mono-component fibers being trilobal polypropylene fibers.

5. The system of claim 3:
the bi-component fibers comprising a polyethylene sheath and a polyester core;
the mono-component fibers being round polypropylene fibers.

6. The system of claim 1, the nonwoven blend of fibers comprising approximately 65% bi-component fibers and approximately 35% mono-component fibers.

7. A filter, comprising:
a bi-component fiber comprising a core, the core having a first melting temperature, the bi-component fiber further comprising a sheath surrounding the core, the sheath having a second melting temperature, the second melting temperature being lower than the first melting temperature; and
a mono-component fiber bonded to the bi-component fiber, the mono-component fiber having a shaped cross-section, the mono-component having a third melting temperature, the third melting temperature being not less than the second melting temperature, the bi-component fiber and the mono-component fiber being located in a nonwoven blend of fibers.

8. The filter of claim 7, the bi-component fiber having a linear mass density of between approximately 0.5 decitex (dtex) and approximately 30 dtex.

9. The filter of claim 7, the mono-component fiber having a linear mass density of between approximately 0.5 decitex (dtex) and approximately 30 dtex.

10. The filter of claim 7, the core comprising a first polymer.

11. The filter of claim 10, the first polymer being one selected from the group consisting of:
a polyolefin;
a polyester;
a polyamide;
a polylactic acid; and
a biodegradable thermoplastic polymer,

12. The filter of claim 10, the sheath comprising a second polymer, the second polymer being different from the first polymer.

13. The filter of claim 12, the second polymer being one selected from the group consisting of:
a polyolefin;
a co-polyester; and
a co-polyamide.

14. The filter of claim 12, the mono-component fiber comprising a third polymer.

15. The filter of claim 14, the third polymer being one selected from the group consisting of:
a polyolefin;
a co-polyester;
a co-polyamide; and
a polypropylene.

16. The filter of claim 7, the shaped cross-section being one selected from the group consisting of:
a trilobal cross-section;
a pentalobal cross-section;
a delta cross-section;
a hollow cross-section;
a flat cross-section; and
a cross-shaped cross-section.

17. The filter of claim 7, the mono-component fiber being one selected from the group consisting of:
a polyolefin fiber;
a co-polyester fiber;
a co-polyamide fiber; and
a polypropylene fiber.

18. The system of claim 7, the nonwoven blend of fibers comprising approximately 85% bi-component fibers and approximately 15% mono-component fibers.

19. The system of claim 7, the nonwoven blend of fibers comprising approximately 75% bi-component fibers and approximately 25% mono-component fibers.

20. The system of claim 7, the nonwoven blend of fibers comprising more than approximately 5% mono-component fibers but less than approximately 50% mono-component fibers.
